(19) United States
(12) Patent Application Publication
(10) Pub. No.: US 2009/0273672 A1
(43) Pub. Date: Nov. 5, 2009

(54) VEHICLE RECORDING SYSTEM AND METHOD

(76) Inventor: Evgeni Koudritski, Maple (CA)

Correspondence Address: BERESKIN AND PARR LLP/S.E.N.C.R.L., s.r.l., 40 KING STREET WEST, BOX 401, TORONTO, ON, M5H 3Y2, CA

(21) Appl. No.: 12/113,316

(22) Filed: May 1, 2008

(51) Int. Cl. H04N 7/18

(52) U.S. Cl. 348/148; 348/E07.085

(57) ABSTRACT

A vehicle recording system for providing vehicle data, including video data, of conditions surrounding road and parking events. In response to a triggering event, the system stores the vehicle data from a previous time interval and a subsequent time interval in a memory device. In some embodiments, the system may change the frequency at which data is captured based on information from proximity sensors and/or the vehicle ignition.

### TECHNICAL FIELD

The described embodiments relate to vehicle recording systems and methods for capturing video and other information regarding a vehicle and its surroundings.

### BACKGROUND

When owning and/or operating a vehicle, many types of incidents may occur in which the owner or operator of the vehicle would benefit from having information regarding the conditions in and around the vehicle. For instance, when a traffic accident occurs, it may be helpful to have information such as the speed of the vehicle and other conditions which may have contributed to the accident. Similarly, when a vehicle is broken into or vandalized, it may be useful to have video data of the incident. Vehicle recording systems may be used to collect and store such data. This data can then be analyzed and possibly used as evidence.

Many known vehicle recording systems require a video cassette recorder or large capacity hard drive in order to store large volumes of information relating to, for example, an entire trip. However, it is often not necessary to store information relating to a long period of time in order to obtain desired information regarding a particular event. Other previous systems capture data only after a triggering event, such as the activation of a user-activated switch, has occurred.

### BRIEF DESCRIPTION OF THE DRAWINGS

Embodiments are described in further detail below, by way of example only, with reference to the accompanying drawings, in which:

FIG. 1 is a block diagram of an exemplary embodiment of the vehicle recording system;

FIG. 2 is a block diagram of an exemplary embodiment of a video capturing device;

FIG. 3 is a block diagram of another exemplary embodiment of the vehicle recording system;

FIG. 4 is a block diagram of another exemplary embodiment of a video capturing device;

FIG. 5 is a block diagram of an exemplary embodiment of a control unit;

FIG. 6 is a flowchart illustrating an exemplary behavior of the vehicle recording system.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understating of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

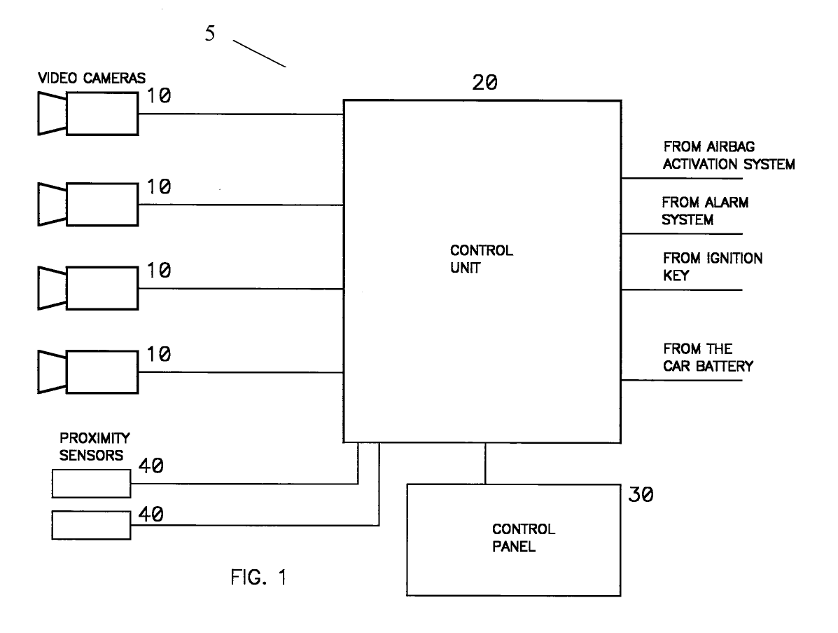

Referring first to FIG. 1, an exemplary embodiment of a video recording system 5 is shown. The video recording system 5 includes a video capturing devices 10, a control unit 20, a control panel 30 and proximity sensors 40.

The control panel 30 may include some number of lights (not shown) which indicate the status of the system. The control panel 30 may also include a user-activated switch (not shown) used to trigger the vehicle recording system 5.

The control unit 20 is designed to receive one or more signals indicating that a triggering event has occurred. This triggering event may be, for example, the activation of a user-activated switch, the deployment of a vehicle airbag, or the activation of a vehicle alarm system. The control unit 20 also receives information from the vehicle ignition in order to determine whether or not the vehicle is in operation. The control unit 20 receives power for the vehicle recording system 5 from the vehicle battery (not shown).

The control unit 20 also receives signals from the proximity sensors 40. The proximity sensors 40 are capable of determining when an object, such as a person or another vehicle, has come within a certain distance of the vehicle. For example, the proximity sensors may be ultrasonic sensors such as the KL-A1840H07-W produced by Kaili or the sensors included in the 8 Sensor Front & Rear Parking Kit SB301-8 sold by Sports Imports Limited. The control unit 20 may also receive data from the video capturing devices 10 and send signals to the video capturing devices 10 to indicate, for example, the frequency at which they should capture the video data.

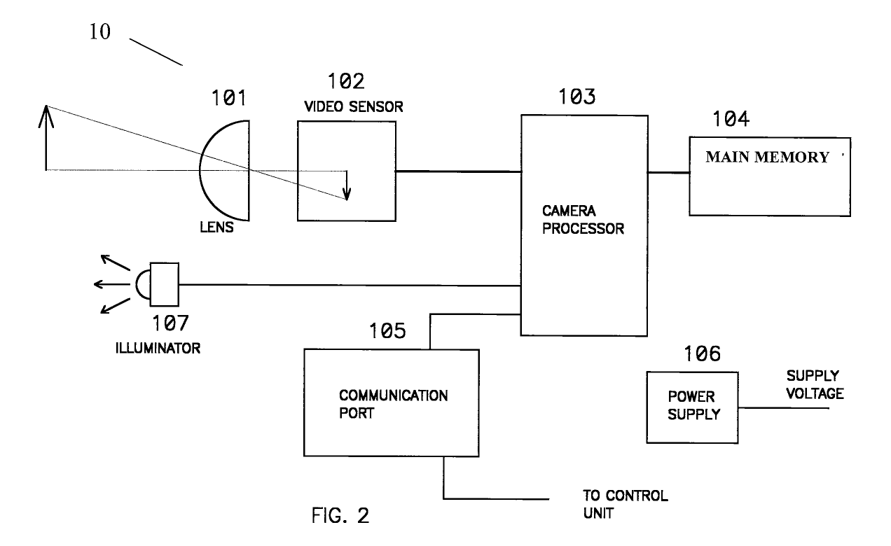

Referring now to FIG. 2, an exemplary embodiment of a video capturing device 10 is shown. In this embodiment, each video capturing device 10 includes a lens 101, a video sensor 102, a camera processor 103, a main memory device 104, a communication port 105, a power supply 106 and an illuminator 107. Optical images created by lens 101 are converted into electrical signals by the video sensor 102. The video sensor generates a digital data stream for the camera processor 103. The camera processor 103 may then convert or compress the digital data to any acceptable video format (e.g. MPEG, DivX or other). The illuminator 107 lights up the image area being recorded by the video capturing device 10.

Once the data is compressed, the camera processor 103 stores the data in an internal memory (not shown). The camera processor 103 collects data in the internal memory continuously during the normal operation of the vehicle. The camera processor 103 keeps each frame in internal memory for at least a previous time interval Tp at which time it may be overwritten. When the control unit 20 receives a signal indicating that a triggering event has occurred, it sends a signal to the video capturing devices 10. Once the signal is received from the control unit 20, the camera processor 103 stores the data from the previous time interval Tp in the main memory 104 and continues to collect data in the internal memory for a subsequent time interval Ts. The data for the subsequent time interval Ts can be simultaneously stored in the main memory 104 or, once the camera processor 103 has collected all the data for the subsequent time interval Ts in the internal memory, it can all be written to the main memory 104. Alternatively, the camera processor 103 may wait to store the data from the previous time interval Tp until all the data for the subsequent time interval Ts has been collected in the internal memory and then the camera processor 103 may write all the data from both time intervals to the main memory 104 at the same time. Regardless of the sequence in which the data is stored, at this point, the main memory 104 will include data for the previous time interval Tp before the triggering event and the subsequent time interval Ts including and after the triggering event.

The previous and subsequent time intervals Tp, Ts may be the same or different and may be configurable by the user or administrator or they may be set at the time the vehicle recording system 5 is manufactured. In any event, the time intervals Tp, Ts can be set so that data is collected for any suitable period of time before and after the event to allow an analysis of the circumstances surrounding the triggering event. For example, if the triggering event is the deployment of a vehicle airbag during a collision, the vehicle data stored in the main memory 104 should help to clarify the cause of the accident and the steps that were taken immediately afterward.

It is also possible that the length of the previous and subsequent time periods Tp, Ts may vary depending on the type of triggering event. In this case, the vehicle recording system 5 could continuously store data for the maximum previous time period and, when a triggering event occurred, the data from the previous time period associated with that particular event would be stored in the main memory 104 along with data from the subsequent time period for that particular event.

In this embodiment, the main memory 104 is a removable memory device, such as a flash card, but the memory may also be of a non-removable type. If the main memory 104 is a removable memory device, the memory device may be removed from the vehicle recording system and downloaded into another device, such as a personal computer, for viewing and analysis. If the memory device is not removable, the data may be downloaded from the video capturing device 10 by connecting another device directly to the video capturing device 10 (such as via USB or FireWire (IEEE 1394) bus connections). Alternatively, the video recording devices 10 themselves may be removable such that an entire video recording device 10, and the data contained therein, may be removed from the vehicle and connected to another device, such as a personal computer, so that the data can be downloaded. As another alternative, the vehicle recording device 5 may contain a display from which the data may be viewed. In yet another alternative embodiment, the internal memory and the main memory 104 may be the same memory device.

The communication port 105 provides a bi-directional connection to the control unit 20 (shown in FIG. 1). This allows the control unit 20 to send control signals to the video capturing devices 10 and allows the video capturing devices 10 to send status signals to the control unit 20. The communication port 105 may, for example, be an infrared wireless communication port, an RF wireless communication port, a wired communication port or an optical fiber connection.

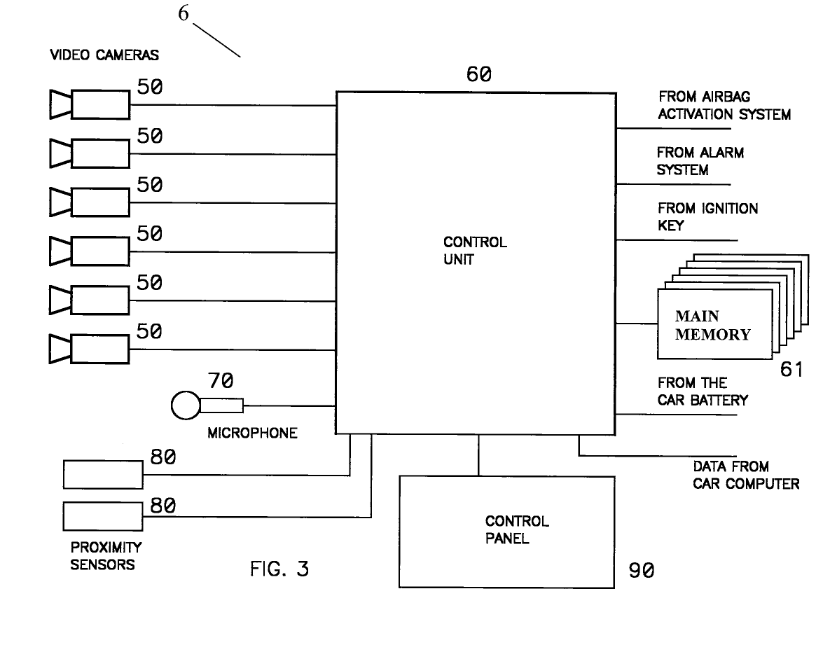

Referring now to FIG. 3, a vehicle recording system 6 according to a second embodiment of the invention is shown. The vehicle recording system 6 contains video capturing devices 50, a control unit 60, a main memory 61, a microphone 70, proximity sensors 80 and a control panel 90. In this embodiment, the main memory 61 comprises a removable memory device, such as a flash card. However, as explained above, the main memory 61 may be any type of removable or non-removable memory suitable for storing video data and other information. Preferably, the proximity sensors 80 are identical to the proximity sensors 40 of the embodiment of FIG. 1.

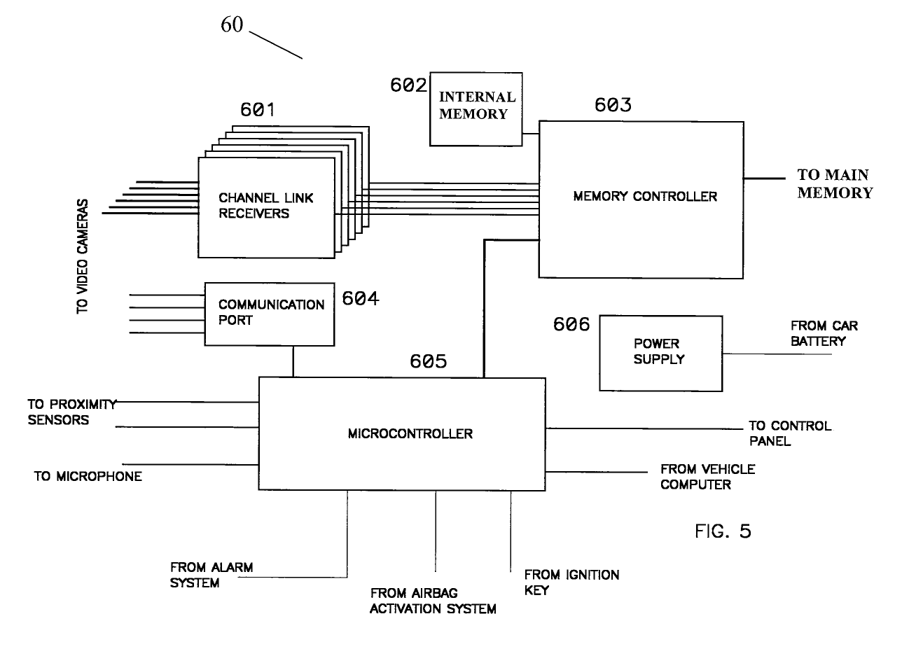

The vehicle recording system 6, shown in FIG. 3, differs from the vehicle recording system 5, shown in FIG. 1, in that the video data from all the video capturing devices 50 is stored in a single internal memory 602 (shown in FIG. 5) as opposed to each video capturing device 10 storing its own data in its own internal memory. Similarly, the vehicle recording system 6 of FIG. 3 includes a single main memory 61 as opposed to one main memory 104 for each video capturing device 10 as shown in FIG. 2. The vehicle recording system 5 shown in FIG. 1 may be less expensive to manufacture and, hence, may be better suited to applications such as personal vehicles. With the vehicle recording system 6 shown in FIG. 3, the control unit 60, including the main memory 602, may be placed in a lockable container to prevent damage as well as unauthorized access. Hence, this embodiment may be better suited to commercial and special vehicles, such as police cruisers, where it may be more important to ensure that data is kept secure and cannot be tampered with.

The control unit 60 receives audio data from in and/or around the vehicle from the microphone 70. The control unit 60 may also receive data from the vehicle computer (not shown) which may be stored in memory along with the video data from the video capturing devices. This data may include, for example, information regarding the speed of the vehicle, braking information, the status of the turn signals or the status of the seat belts.

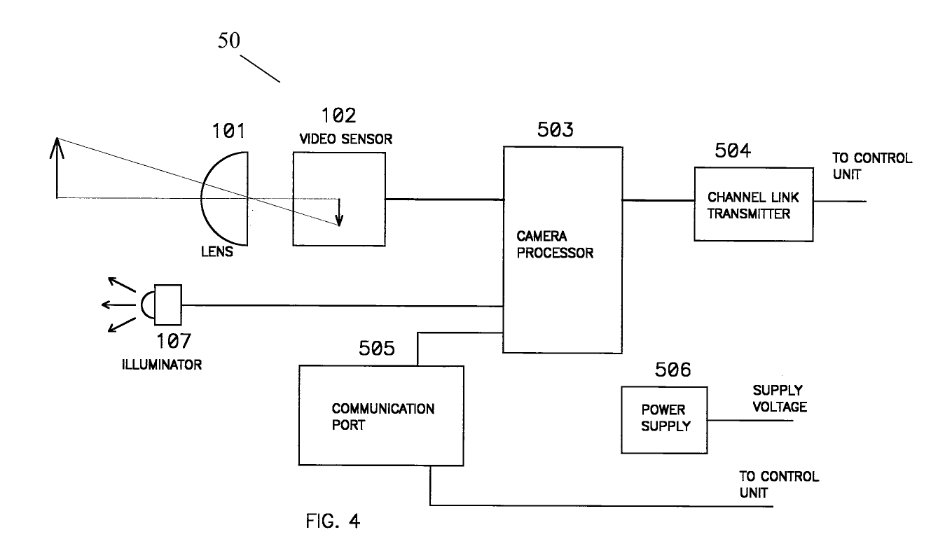

Referring now to FIG. 4, one of the video capturing devices 50 is shown. Each video capturing device 50 in this embodiment includes a lens 101, a video sensor 102, a camera processor 503, a channel link transmitter 504, an illuminator 107, a communication port 505 and a power supply 506. As with the previous embodiment, optical images are created by the lens 101 and converted into electrical signals by the video sensor 102. The video sensor 102 generates a digital data stream for the camera processor 503. In this embodiment, the camera processor 503 compresses the digital data stream and sends it to the control unit 60 through the channel link transmitter 504. Alternatively, the video data may be sent from the video capturing devices 50 to the control unit 60 via, for example, an analogue video transfer by coaxial cable, by fiber cable or via RF translation.

The communication port 505 provides a bi-directional connection to the control unit 60. This allows the control unit 60 to send control signals to the video capturing devices 50 and allows the video capturing devices 50 to send status signals to the control unit 60. The communication port 505 may, for example, be an infrared wireless communication port, an RF wireless communication port, a wired communication port or an optical fiber connection.

Referring now to FIG. 5, an exemplary embodiment of the control unit 60 is shown. The control unit 60 includes one channel link receiver 601 for each video capturing device 50 in the video recording system 6. Each channel link receiver 601 receives video data from a corresponding one of the video capturing devices 50. The control unit 60 also contains a memory controller 603, an internal memory 602, a control unit communication port 604, a micro controller 605 and a power supply 606.

Video data from the channel link receivers 601 is continually stored by the memory controller 603 in the internal memory 602 such that the internal memory 602 keeps each frame in memory for at least the previous time interval Tp. When a triggering event occurs, the memory controller 603 receives a command from the microcontroller 605 to copy the video data for the previous time period from the internal memory 602 to the main memory 61 along with video data from the subsequent time period Ts following the event. The memory controller 603 may also receive and store other data from the microcontroller 605 such as audio signals, time, data and other information from the vehicle computer in the main memory 61.

The internal memory 602 may be a random access memory (RAM), as shown in FIG. 5, or any other type of memory which can temporarily store the video data.

The control unit communication port 604 communicates with the communication port 505 of the video capturing devices 50 (shown in FIG. 4). As with the communication port 505 of the video capturing devices 50, the control unit communications port 605 may, for example, be an infrared wireless communication port, an RF wireless communication port, a wired communication port or an optical fiber connection.

The microcontroller 605 may receive signals indicating that a triggering event has occurred, such as from the user-activated switch, the vehicle alarm system or the vehicle airbag activation system. The microcontroller 605 also receives data from the vehicle ignition key in order to determine whether or not the vehicle is in operation. The microcontroller 605 may also receive data from the vehicle computer and microphone 70 to be sent to the memory controller 603 and stored in main memory 61 when a triggering event occurs.

Referring now to FIGS. 3-5, the microcontroller 605 may receive data from the proximity sensors 80 indicating that an object, such as a person or another vehicle, has come within a certain distance of the vehicle. In response to data from the proximity sensors 80, the microcontroller 605 may send a signal to the video capturing devices to change to the frequency at which video data is being captured.

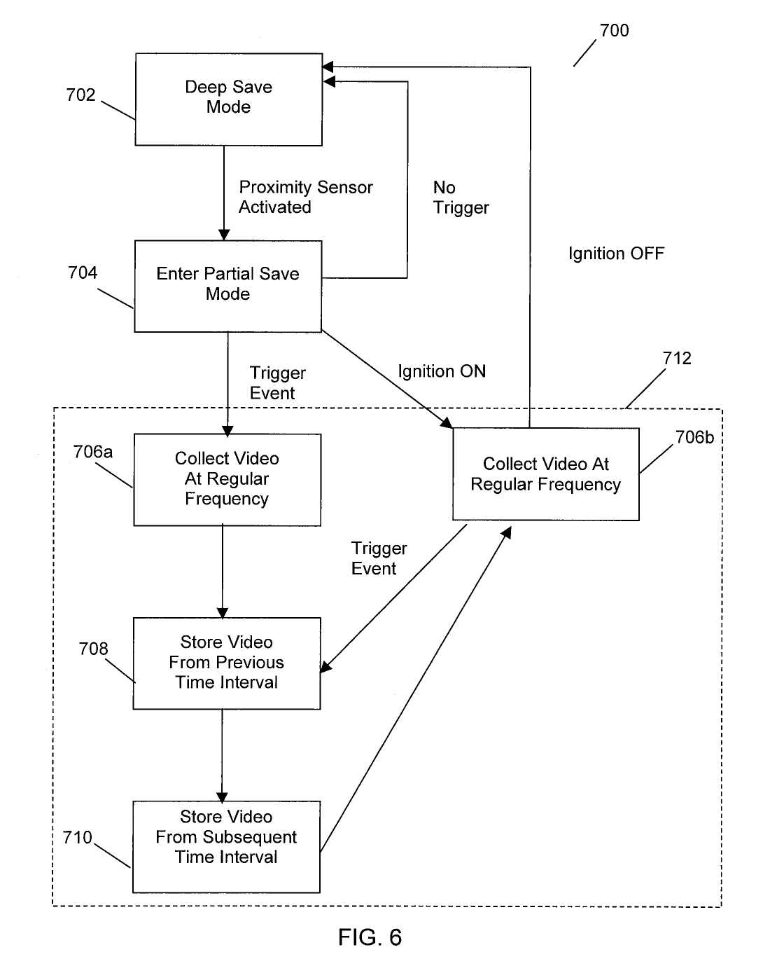

Referring now to FIG. 6, there is shown a flowchart illustrating an exemplary method 700 of operation of the vehicle recording system 6. According to some embodiments, at any given time, the vehicle recording system 6 may be operating in one of three operating modes, namely deep save mode, partial save mode, or regular mode. The control unit 60 uses signals from the vehicle ignition key and the proximity sensors 80 to determine which operation mode setting it should be operating under.

If the vehicle ignition key is in the OFF position, meaning that the vehicle is not in operation, the control unit 60 puts the system in deep save mode at step 702. Upon entering deep save mode, the control unit 60 sends a signal to the video capturing devices 50 through communications port 604 to begin capturing still images at a low frequency, for example at a frequency of one image per second. At this point, all lights (e.g. LEDs) on control panel 90 are turned off.

When an object, such as a person or another vehicle, comes within a certain distance of the vehicle, the proximity sensors 80 will send a signal to the control unit 60 and the vehicle recording system 6 will enter a partial save mode at step 704. Upon entering the partial save mode, the control unit 60 sends a signal to the video capturing devices 50 through communications port 604 to begin capturing images at a moderate frequency, for example at a frequency of three images per second. At this point, the lights on the control panel 90 may start flashing. If there has been no triggering event within a certain period of time, for example three minutes, and the vehicle ignition has not been turned on, then the vehicle recording system 6 will return to the deep save mode at step 702.

If, at step 704, there is a triggering event, such as the activation of the vehicle alarm or an impact from another vehicle, the vehicle recording system 6 enters the regular mode 712 and moves to step 706a. At step 706a, the control unit 60 sends a signal to the video capturing devices 50 through communications port 604 to begin to capturing images at a regular frequency, for example at a frequency of fifteen frames per second.

As explained above, as video data is captured by the video recording devices 50, it is sent to the control unit 60 via the channel link receivers 601. The video data is then sent to the memory controller 603 and stored in the internal memory 602. Each frame of the video data is stored in the internal memory 602 for at least the previous time interval Tp, at which point it may be overwritten.

At step 708, the memory controller 603 copies the video data from the previous time interval Tp stored in the internal memory 602 into the main memory 104. This data will include images captured at the moderate frequency while the vehicle recording system 6 was in the partial save mode 704 and may include images captured at the lower frequency while the vehicle recording system 6 was in the deep save mode 702.

The video recording devices 50 will continue to capture video data for the subsequent time interval Ts. The video data will continue to be sent to the control unit 60 through the channel link receivers 601 and stored by the memory controller 603 in the internal memory 602. At step 710, video data collected from the video capturing devices 50 for the subsequent time interval Ts will be copied by the memory controller 603 from the internal memory 602 into the main memory 104 along with any other data collected by the microcontroller 605. At this point, the vehicle recording system 6 will move to step 706b, in which it continually collects video data at the regular frequency. Steps 708, 710, and 706b will repeat each time there is a triggering event until the vehicle ignition is turned off or the main memory is full.

If, at step 704, a person who has come within a certain distance of the vehicle turns on the vehicle ignition, the vehicle recording system 6 will enter the regular mode of operation 712. In the regular mode of operation 712, the control unit 60 sends a signal to the video capturing devices 50 through communications port 604 to continually collect video data at the regular frequency at step 706b. The video data will be stored in the internal memory 602, as explained above. When the control panel 605 receives a signal indicating that a triggering event has occurred, the vehicle recording system 6 moves to step 708 as explained above. Once the video data from the previous and subsequent time intervals has been stored in main memory 104, along with any additional data, at steps 708 and 710 respectively, the vehicle recording system 6 returns to the regular mode at step 712.

If, at step 706b, the vehicle ignition is turned off, the vehicle recording system 6 returns from regular mode 712 to the deep save mode 702.

Alternatively, in some embodiments, there may only be two modes of operation, namely deep save mode and regular mode. In these embodiments, as with the method 700 described above, the vehicle recording system 6 would enter deep save mode when the vehicle ignition is turned off. The vehicle recording system 6 would enter regular mode either in response to a triggering event (as with step 706a described above) or in response to the vehicle ignition being turned on (as with step 706b described above). In these embodiments, the activation of a proximity sensor 80 may be considered a triggering event such that the vehicle recording system 6 would go directly from deep save mode (step 702 described above) to regular mode (step 706a described above) upon a proximity sensor 80 being activated.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A recording system for a vehicle comprising:
at least one video capturing device adapted for capturing video data;
a main memory adapted for storing vehicle data, wherein the vehicle data comprises the video data;
a control unit adapted for detecting at least one triggering event, wherein the vehicle data comprises a previous data portion and a subsequent data portion, wherein the previous data portion occurs during a first predetermined time interval prior to the at least one triggering event and the subsequent data portion occurs during a second predetermined time interval, wherein the second predetermined time interval begins with the triggering event;
wherein, upon the control unit detecting the at least one triggering event, the control unit is adapted to cause the previous data portion and the subsequent data portion to be recorded in the main memory.

2. The recording system of claim 1, further comprising an internal memory, wherein the previous data portion is continuously stored in the internal memory, wherein when the control unit detects the at least one triggering event, the previous data portion is copied from the internal memory to the main memory.

3. The recording system of claim 1, further comprising a user-activated switch, wherein the at least one triggering event comprises an activation of the user-activated switch.

4. The recording system of claim 1, wherein the at least one triggering event comprises a deployment of a vehicle airbag.

5. The recording system of claim 1, wherein the vehicle data further comprises at least one data type selected from the group of: time, date, vehicle speed, location, turn signal status, seatbelt status and brake status.

6. The recording system of claim 1, wherein the main memory is a removable memory device.

7. The recording system of claim 1 wherein, when the vehicle is not in operation, the at least one video capturing device records the data at a first frequency and, when the at least one triggering event has occurred, the at least one video capturing device records the video data at a second frequency, wherein the second frequency is higher than the first frequency.

8. The recording system of claim 7, further comprising a proximity sensor adapted to alarm when an object is within a predetermined distance from the vehicle, wherein, when the vehicle is not in operation, the at least one video capturing device records the video data at the first frequency until the proximity sensor alarms, wherein when the proximity sensor alarms, the at least one video capturing device records the video data at a third frequency for a predetermined period of time, wherein the third frequency is higher than the first frequency and lower than the second frequency.

9. The recording system of claim 7, wherein the at least one triggering event is an unauthorized entry into the vehicle.

10. The recording system of claim 7, wherein the at least one triggering event is an activation of a vehicle alarm.

11. The recording system of claim 7, wherein the at least one triggering event is an impact to the vehicle.

12. A method of monitoring a vehicle, the method comprising:
capturing vehicle data, wherein the vehicle data comprises video data;
detecting that one of at least one triggering events has occurred;
storing the vehicle data in a main memory following the triggering event, wherein the vehicle data comprises a previous data portion and a subsequent data portion, wherein the previous data portion occurs during a first predetermined time interval prior to the at least one triggering event, and the subsequent data portion occurs during a second predetermined time interval, wherein the second predetermined time interval begins with the triggering event.

13. The method of claim 12, further comprising continuously storing the previous data portion in an internal memory, wherein when the control unit detects the at least one triggering event, the previous data portion is copied from the internal memory to the main memory.

14. The method of claim 12, wherein the at least one triggering event comprises an activation of a user-activated switch.

15. The method of claim 12, wherein the at least one triggering event comprises a deployment of a vehicle airbag.

16. The method of claim 12, wherein the vehicle data further comprises at least one data type selected from the group of: time, date, vehicle speed, location, turn signal status, seat belt status and brake status.

17. The method of claim 12, wherein the main memory is a removable memory device.

18. The method of claim 12, wherein capturing vehicle data comprises, when the vehicle is not in operation, recording the video data at a first frequency and, when the at least one triggering event has occurred, recording the video data at a second frequency, wherein the second frequency is higher than the first frequency.

19. The method of claim 18, wherein capturing vehicle data comprises, when the vehicle is not in operation, recording the video data at a first frequency until a proximity sensor alarms and recording the video data at a third frequency for a predetermined period of time after the proximity sensor alarms, wherein the proximity sensor is adapted to alarm when an object is within a predetermined distance from the vehicle and wherein the third frequency is higher than the first frequency and lower than the second frequency.

20. The method of claim 18, wherein capturing vehicle data further comprises, when the at least one triggering event has occurred, recording the video data at a third frequency, wherein the third frequency is higher than the second frequency.

21. The method of claim 18, wherein the at least one triggering event is an unauthorized entry into the vehicle.

22. The method of claim 18, wherein the at least one triggering event is an activation of a vehicle alarm.

23. The method of claim 18, wherein the at least one triggering event is an impact to the vehicle.
